(19) United States
(12) Patent Application Publication
(10) Pub. No.: US 2007/0262027 A1
(43) Pub. Date: Nov. 15, 2007

(54) Layered filter for treatment of contaminated fluids

(75) Inventors: John A. Krogue, Mineral Wells, TX (US); Daniel Cloud, Weatherford, TX (US); James McQuaid, Mineral Wells, TX (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: PERRY EQUIPMENT CORPORATION

(21) Appl. No.: 11/731,150

(22) Filed: Mar. 30, 2007

Related U.S. Application Data
(60) Provisional application No. 60/787,950, filed on Mar. 31, 2006.

(51) Int. Cl. B01D 15/18

(52) U.S. Cl. 210/688; 156/155; 156/182; 156/285; 156/305; 156/73.1; 210/314; 210/660; 502/407; 502/416

(57) ABSTRACT

A filter for use in the treatment of contaminated fluid is provided. The filter, in an embodiment, includes two filter elements, each substantially flat in shape, for use in removing certain contaminants from the fluid flow. The filter further includes a waste adsorbent material, positioned between the two filter elements for use in removing additional contaminants within the fluid flowing across the filter elements. The waste adsorbent material, in an embodiment, may be a nanosorbent material manufactured from self-assembled monolayers on mesoporous supports (SAMMS). The filter can form a barrier through which contaminated fluid flows for removing certain contaminants from the fluid.

### RELATED U.S. APPLICATION(S)

This application claims priority to U.S. Provisional Patent Application Ser. No. 60/787,950, filed Mar. 31, 2006, which application is hereby incorporated herein by reference.

### TECHNICAL FIELD

The present invention relates to a filter and method for making such filter for use in treatment of contaminated fluids, and more particularly, to a layered filter incorporating the use of self-assembled monolayers on mesoporous supports in the removal of toxic heavy metals from contaminated fluids.

### BACKGROUND ART

Produced fluid, such as water from offshore oil platforms can contain toxic heavy metals, for instance, mercury. In the Gulf of Mexico, mercury levels rarely exceed 100 parts per billion (ppb). However, in the Gulf of Thailand, the average concentration of mercury in produced water can range from about 200 ppb to about 2,000 ppb.

Discharge of mercury into the marine environment in U.S. territorial waters is currently regulated by the U.S. Environmental Protection Agency (EPA) under the Clean Water Act via the National Pollutant Discharge Elimination System permit process. According to environmental standards under 40 CFR § 131.36 for marine environment, limits include about 1800 ppb for acute exposure and about 25 ppb for chronic exposure. International standards for mercury discharges in produced water, on the other hand, range from about 5 ppb in Thailand to about 300 ppb in the North Sea.

Produced water often contains oil that was removed with the water during the bulk oil/water separation process. As an example, the produced water from the North Sea fields contains about 15-30 parts per million (ppm) dispersed oil with benzene, toluene, ethylbenzene, and xylene (BTEX); naphthalene, phenanthrene, dibenzothiophene (NPD), polycyclic aromatic hydrocarbon (PAH), phenol, and organic acid concentrations ranging from about 0.06 ppm to about 760 ppm. Additionally, these produced waters contain toxic heavy metals, such as mercury, cadmium, lead, and copper in concentrations ranging from less than about 0.1 ppb to about 82 ppb. The presence of a complex mix of constituents coupled with a high concentration of dissolved salts can present a challenge for heavy metal removal using currently available conventional technologies.

In particular, existing technologies for metal and mercury removal from diluted wastewater include activated carbon adsorption, sulfur-impregnated activated carbon, microemulsion liquid membranes, ion exchange, and colloid precipitate flotation. These technologies may not be suitable for water treatment because of poor metal loading (e.g., metal uptake less than 20% of the mass of the adsorber material) and selectivity, (interference from other abundant ions in groundwater). In addition, mercury may be present in species other than elemental. So the method must be able to remove these other species, such as methyl mercury, etc. Furthermore, they lack stability for metal-laden products so that they are not disposable directly as a permanent waste form. As a result, secondary treatment is required to dispose or stabilize the separated mercury or the mercury-laden products. Mercury removal from non-aqueous sludge, adsorbed liquids, or partially- or fully-stabilized sludges, and mercury-contaminated soil is difficult because (1) the non-aqueous nature of some wastes prevents the easy access of leaching agents, (2) some waste streams with large volumes make the thermal desorption process expensive, and (3) the treatment of some waste streams are technically difficult because of the nature of the wastes.

Mercury removal from offgas in vitrifiers and in mercury thermal desorption processes is usually accomplished through active carbon adsorption. However, the carbon-based adsorbents are only effective enough to remove 75 to 99.9% of the mercury with a loading capacity equivalent to 1-20% of the mass of the adsorber material. A last step, mercury amalgamation using expensive gold, usually is needed to achieve the EPA air release standard. A carbon bed usually is used later in the offgas system, where the temperature is generally lower than 250° F. In the sulfur impregnated carbon process, mercury is adsorbed to the carbon, which is much weaker than the covalent bond formed with, for instance, surface functionalized mesoporous material. As a result, the adsorbed mercury needs secondary stabilization because the mercury-laden carbon does not have the desired long-term chemical durability due to the weak bonding between the mercury and activated carbon. In addition, a large portion of the pores in the active carbon are large enough for the entry of microbes to solubilize the adsorbed mercury-sulfur compounds. The mercury loading is limited to about 0.2 g/g of the materials.

The microemulsion liquid membrane technique uses an oleic acid microemulsion liquid membrane containing sulfuric acid as the internal phase to reduce the wastewater mercury concentration from about 460 ppm to about 0.84 ppm. However, it involves multiple steps of extraction, stripping, demulsification, and recovery of mercury by electrolysis and uses large volumes of organic solvents. The liquid membrane swelling has a negative impact on extraction efficiency.

The slow kinetics of the metal-ion exchanger reaction requires long contacting times. This process also generates large volumes of organic secondary wastes. One ion exchange process utilizes Duolite™ GT-73 ion exchange organic resin to reduce the mercury level in wastewater from about 2 ppm to below about 10 ppb. Oxidation of the resin results in substantially reduced resin life and an inability to reduce the mercury level to below the permitted level of less than about 0.1 ppb. The mercury loading is also limited because the high binding capacity of most soils to mercury cations makes the ion-exchange process ineffective, especially when the large amounts of Ca²⁺ from soil saturate the cation capacity of the ion exchanger. In addition, the mercury-laden organic resin does not have the ability to resist microbe attack. Thus, mercury can be released into the environment if it is disposed of as a waste form. In addition to interference from other cations in the solution besides the mercury-containing ions, the ion exchange process is simply not effective in removing neutral mercury compounds, such as HgCl₂, Hg(OH)₂, and organic mercury species, such as methylmercury, which is the most toxic form of mercury. This ion-exchange process is also not effective in removing mercury from non-aqueous solutions and adsorbing liquids.

The reported removal of metal from water by colloid precipitate flotation reduces mercury concentration from about 160 ppb to about 1.6 ppb. This process involves the addition of HCl to adjust the wastewater to pH 1, addition of Na₂S and oleic acid solutions to the wastewater, and removal of colloids from the wastewater. In this process, the treated wastewater is potentially contaminated with the Na₂S, oleic acid, and HCl. The separated mercury needs further treatment to be stabilized as a permanent waste form.

Acidic halide solution leaching and oxidative extractions can also be used in mobilizing mercury in soils. For example KI/I₂ solutions enhance dissolution of mercury by oxidization and complexation. Other oxidative extractants based on hypochlorite solutions have also been used in mobilizing mercury from solid wastes. Nevertheless, no effective treatment technology has been developed for removing the mercury contained in these wastes. Since leaching technologies rely upon a solubilization process wherein the solubilized target (e.g. mercury) reaches a dissolution/precipitation equilibrium between the solution and solid wastes, further dissolution of the contaminants from the solid wastes is prevented once equilibrium is reached. In addition, soils are usually a good target ion absorber that inhibits the transfer of the target ion from soils to solution.

The removal of mercury from nonaqueous liquids, adsorbed liquids, soils, or partially-or-fully-stabilized sludge at prototypic process rates has been lacking. This is mainly because the mercury contaminants in actual wastes are much more complicated than the mercury systems addressed by many laboratory-scale tests that are usually developed based on some simple mercury salts. The actual mercury contaminants in any actual wastes almost always contain inorganic mercury (e.g., divalent cation Hg²⁺, monovalent Hg₂²⁺, and neutral compounds such as HgCl₂, Hg[OH]₂,); organic mercury, such as methylmercury (e.g., CH₃ HgCH₃ or CH₃ Hg⁺) as a result of enzymatic reaction in the sludge; and metallic mercury, because of reduction. Since many laboratory technologies are developed for only one form of mercury, demonstrations using actual wastes are not be successful.

Other metals that are of interest for remediation and industrial separations include but are not limited to silver, lead, uranium, plutonium, neptunium, americium, cadmium and combinations thereof. Present methods of separation include but are not limited to ion exchangers, precipitation, membrane separations, and combinations thereof. These methods usually have the disadvantages of low efficiencies, complex procedures, and high operation costs.

Accordingly, it would be advantageous to provide an apparatus and method that can be used to remove heavy metals, such as mercury, cadmium, and lead from complex waste fluids, such as produced water, in a significant amount and in a cost effective manner.

### SUMMARY OF THE INVENTION

The present invention, in one embodiment, provides a filter for use in the treatment of contaminated fluid. The filter, in an embodiment, includes two filter elements, each substantially flat in shape, for use in removing certain contaminants from the fluid flow. The filter further includes a waste adsorbent material, positioned between the two filter elements for use in removing additional contaminants within the fluid flowing across the filter elements. The waste adsorbent material, in an embodiment, may be a nanosorbent material manufactured from self-assembled monolayers on mesoporous supports (SAMMS). The filter can be enlarged by overlapping or by ultrasonically joing a plurality of filters to one another. The filter can form a barrier through which contaminated fluid flows, so that targeted contaminants can be removed.

The present invention, in another embodiment, a method of manufacturing a filter for use in the treatment of contaminated fluid. The method includes providing a two filter elements, each having an inner surface and an outer surface, for use in removing certain contaminants from the fluid flow. In an embodiment, each of the filter elements can be substantially flat in shape, similar to a sheet. Next, one of the filter elements can be placed onto a surface, so that its inner surface can be exposed. Thereafter, a layer of a waste adsorbent material may be placed on to the exposed inner surface of the one filter element. The thickness and uniformity of the layer of adsorbent material can be controlled, depending on the application. Subsequently, the other filter element can be positioned on top of the layer of adsorbent material, such that its inner surface directly contacts the layer of adsorbent material. The assembled filter may then be heated, so that a bond can be created between the tow filter elements to trap the layer of adsorbent material therebetween. Should a longer or wider filter be desired, multiple filters can be placed adjacent one another and joined together using method known in the art.

The present invention further provides a method for treatment of contaminated fluid. The method includes providing a filter having a first sheet of filter element, a second sheet of filter element in opposing relations thereto, and a layer of a waste adsorbent material disposed between the first and second filter elements. Next, the filter may be placed over a surface of a contaminated area where seepage can be an issue, so as to form a barrier through which contaminated fluid may flow. To the extent desired, multiple filters may be overlapped across the contaminated area. Contaminated fluid may then be allowed to seep across the first filter element directly in contact with the contaminated area, so that contaminants of a certain size can be removed. The fluid may be permitted to continue to seep from the first filter element, across the adsorbent material, so that additional contaminants may be adsorbed by the adsorbent material and removed from the fluid. Thereafter, the fluid treated from the adsorbent material can be allowed to move through the second filter element and away from the filter.

### BRIEF DESCRIPTION OF DRAWINGS

FIG. 1 illustrates a filter for use in the treatment of contaminated fluids in accordance with one embodiment of the present invention.

FIGS. 2A-B illustrate, in accordance with another embodiment of the present invention, the filter shown in FIG. 1 used in the treatment of contaminated fluids.

### DESCRIPTION OF SPECIFIC EMBODIMENTS

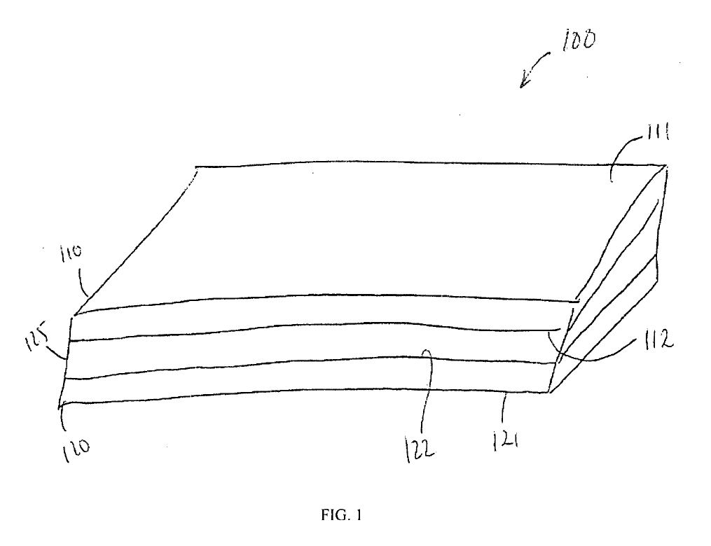

With reference to FIG. 1, the present invention provides, in one embodiment, a filter 100 through which contaminated fluid may be directed for subsequent removal of contaminants within the fluid therefrom. Fluids which may be treated in connection with the present invention may be viscous, such as oil, or non-viscous, such as a liquid or a gas. Contaminants that may be removed by the system of the present invention include heavy metals, such as mercury, arsenic, cadmium, lead from complex fluids or waste streams, such as produced water, and mercury from a variety of waste solutions and contaminated waste oils.

The filter 100, in an embodiment, includes a first filter element 110 and a second filter element 120. Filter element 110, as illustrated, can be provided with an outer surface 111 and an inner surface 112. Likewise, filter element 120 includes an outer surface 121 and an inner surface 122. Filter elements 110 and 120, in one embodiment, may be a substantially a flat sheet of filtration media designed for removing certain contaminants, for instance, solid and liquid contaminants, from the fluid flow. To that end, the filter elements 110, 120 may be made from a fluid permeable material, such as a synthetic material, e.g., polyester, polypropylene, nylon, or a combination thereof, to permit fluid to flow therethrough. Other materials from which the outer filter element may be made include inorganic components, like fiberglass or ceramic, microglass, melt-blown, micron synthetic, organic cellulose, paper etc. or a combination thereof. In an embodiment, the filter elements 110 and 120 may be made from non-woven material. An example of such a material from which the filter elements may be made is disclosed in U.S. Pat. No. 5,827,430, entitled Coreless and Spirally Wound Non-Woven Filter Element, and in U.S. Pat. No. 5,893,956, entitled Method of Making a Filter Element. Both of these patents are hereby incorporated herein by reference. The material from which the filter elements 110 and 120 may be made can be provided with a substantially tortuous path from an outer surface of each filter to an inner surface of each filter. In that way, fluid flowing across the filter elements can be forced to follow a tortuous path so that contaminants, for instance, solid contaminants of a particular size, can be trapped within the filter element. Although illustrated as being square in shape, it should be appreciated that the filter elements 110 and 120 may be provided in any geometric shape, including rectangular, square, circular, or any shape necessary for the particular application.

In addition, filter elements 110 and 120 of filter 100 may be provided with a thickness sufficient to remove certain solid contaminants. In an embodiment, filter elements 110 and 120 may have a thickness of about 0.1 inch or greater. Of course, the thickness of filter elements 110 and 120, and other size related dimensions, may be varied depending on the particular application, and the environment within which the filter 100 is used.

Filter 100 further includes an adsorbent material 125, positioned between the first filter element 110 and the second filter element 120. The waste adsorbent material 125 may be used for removing contaminants, for example, heavy metals similar to those disclosed above, within the fluid flowing across the first filter element 110 and/or the second filter element 120. It should be appreciated that placement of the adsorbent material 125 between the filter elements 110 and 120 helps to contain and retain the adsorbent material 125 within filter 100. The waste adsorbent material 125, in an embodiment, may be a nanosorbent material manufactured from self-assembled monolayers on mesoporous supports (SAMMS). The support, in an embodiment, may be made from various porous materials, including silica. An example of a SAMMS material that can be used in connection with apparatus 100 of the present invention includes thiol-SAMMS, such as that disclosed in U.S. Pat. No. 6,326,326, which patent is hereby incorporated herein by reference.

In accordance with one embodiment of the present invention, the waste adsorbent material 125 may be porous particles ranging from about 5 microns to about 200 microns in size. In an embodiment, the particles, on average, range from about 50 microns to about 80 microns in size, include a pore size ranging from about 2 nanometers (nm) to about 7 nm, and may be provided with an apparent density of ranging from about 0.2 grams/milliliter to about 0.4 grams/milliliter. Due to the size of the adsorbent material 125, it should be noted that each of the filter elements 110 and 120 may be designed to limit its permeability to the adsorbent material 125, so as to minimize movement of the adsorbent material 125 across the filter elements 110 and 120.

In manufacturing filter 100 of the present invention, the first filter element 110 and second filter element 120 may be made by blending raw fibers of various size, as disclosed in U.S. Pat. Nos. 5,827,430 and 5,893,956, both of which are incorporated by reference. Thereafter, one of the filter elements, for example, filter element 120 can then be positioned on to a surface, for instance, a substantially flat surface, so that its inner surface 122 may be exposed. Once exposed, the inner surface 122 of filter element 120 can be covered with a layer of the adsorbent material 125. Of course, multiple layers of the adsorbent material 125 can be applied. The thickness and uniformity of this layer, as well as the amount of waste adsorbent material 125, can be predetermined and controlled, depending on the commercial application. Alternatively, the adsorbent material 125 can be applied to a sheet (not shown) of a permeable material and the sheet placed on to the inner surface 122 of filter element 120.

It should be appreciated that the adsorbent material, e.g., SAMMS, can be functionalized with a treatment to specifically target a contaminant in a contaminated fluid. This treatment can be done before or after application of the adsorbent material on to filter element 120, or even after the filter 100 has been formed. To the extent desired, the adsorbent material 125 can further include a different substance or material, e.g., carbon, or a differently functionalized SAMMS. This flexibility can allow for different designs of waste adsorbent material to match specified contaminants the may exist in the fluid being treated.

Next, the remaining filter element, for instance, filter element 110, can be situated in opposing relations to filter element 120, so that its inner surface 112 can be in substantial contact with the adsorbent material 125. Placement of filter element 110 and filter element 120 in such a manner allows the adsorbent material 125 to be sandwiched therebetween to form filter 100. The assembled filter 100 can then be heated, so that a bond can be created between the two filter elements 110, 120, thereby trapping the adsorbent material 125 in the middle. In one embodiment, the edges of the filter elements are heated to create a bond between the edges and around the adsorbent material. To enhance the bond between the filter elements 110 and 120, pressure may be applied to one or both filter elements, so as to compress the filter elements toward one another during heating.

The bond between the filter elements 110, 120 can be created because each filter element may be made of a permeable material that contains a combination of components, such that at least one component of the permeable material has a lower melting point than the remainder of the components. This allows the filter elements 110 and 120 to be melted around the adsorbent material 125, thereby forming the layered filter 100. In fact, the filter elements 110 and 120 can be melted more than once, and still maintain their overall matrix integrity. An advantage of using such a permeable material to make filter elements 110, 120, is the ability to blend different fibers, so as to provide a substantially exact matrix composition to best contain and use the adsorbent material 125 in an optimal way.

Once the layered filter 100 has been heated and compressed, it may then be calendared and ready for use. Thereafter, should a wider or longer filter 100 be required, multiple filters 100 can be placed adjacent one another and joined (i.e. attached) together using techniques known in the art. In one example, ultrasonic welding techniques may be employed to join adjacently situated layered filters 1000, such that multiple layered filters 100 can be coupled together, either along the sides or end to end. In this manner, large sheets of layered filters 100, can be assembled on site for convenience.

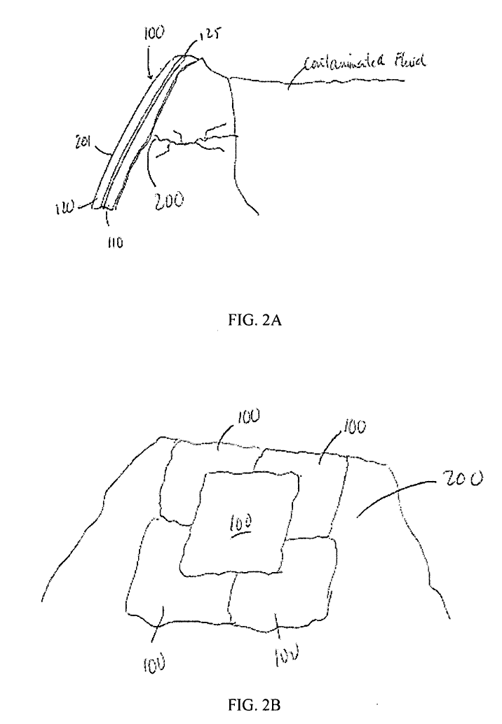

In application, referring now to FIG. 2A, the layered filter 100, can be utilized in a number of different ways to remove heavy metal contaminants from places where seepage (i.e. very low flow rate) can be a problem. For example, a plurality of layered filter 100, can be spread over, for instance, a dirt dam, or can cover the surface of a particular contaminated area 200, so as to form a barrier 201 through which contaminated fluid may flow. To the extent desired or necessary, multiple filters 100 may be placed in overlapping relations (FIG. 2B) across the contaminated area to cover as much of the contaminated area as possible. Once the contaminated area 200 has been substantially covered, contaminated fluid may be permitted to seep across the first filter element 110 that is directly in contact with the contaminated area 200, so that contaminants of a certain size can be removed. The fluid may then be allowed to continue moving from the first filter element, across the adsorbent material 125, so that additional contaminants different from those removed by the filter element 110 in contact with the contaminated area 200 may be adsorbed by the adsorbent material 125 and removed from the fluid. Thereafter, the fluid treated from the adsorbent material 125 can be directed to move through the second filter element 120 and away from the filter 100 and the contaminated area 200.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

What is claimed is:

1. A filter comprising:
a first filter element designed to remove certain contaminants from a fluid flow, the first filter element having an outer surface and an inner surface;
a second filter element having an outer surface, an inner surface, and being positioned in opposing relations to the first filter element, so that its inner surface is facing the inner surface of the first filter element; and
an adsorbent material disposed between the first filter element and the second filter element adjacent the inner surfaces of the filter elements for removing additional contaminants within the fluid flowing across the first filter element.

2. A filter as set forth in claim 1, wherein the filter elements are made from a permeable material.

3. A filter as set forth in claim 2, wherein the permeable material defines a substantially tortuous path from the outer surface to the inner surface of the filter element through which the fluid flow passes.

4. A filter as set forth in claim 3, wherein the permeable material acts to trap contaminants of a predetermined size.

5. A filter as set forth in claim 1, wherein the filter elements are made from a material including one of polyester, polypropylene, nylon, other polymeric materials, fiberglass or ceramic, microglass, melt-blown, micron synthetic, organic cellulose, paper, or a combination thereof.

6. A filter as set forth in claim 1, wherein the filter elements are substantially flat in shape.

7. A filter as set forth in claim 1, wherein the filter elements are provided with a thickness of at least about 0.1 inch.

8. A filter as set forth in claim 1, wherein the fluid flow entering the first filter element is viscous in nature.

9. A filter as set forth in claim 8, wherein the viscous fluid includes one of oils, waste oils, other fluid viscous in nature, or a combination thereof.

10. A filter as set forth in claim 1, wherein the fluid flow entering the first filter element is non-viscous in nature.

11. A filter as set forth in claim 10, wherein the non-viscous fluid includes a liquid or a gas.

12. A filter as set forth in claim 10, wherein the non-viscous fluid includes produced water.

13. A filter as set forth in claim 1, wherein the adsorbent material is designed to remove heavy metals from the fluid flow.

14. A filter as set forth in claim 1, wherein the adsorbent material is designed to removed one of mercury, silver, lead, uranium, plutonium, neptunium, americium, arsenic, cadmium, or a combination thereof.

15. A filter as set forth in claim 1, wherein the adsorbent material includes a porous particle made from self-assembled monolayers on mesoporous supports (SAMMS).

16. A filter as set forth in claim 15, wherein the particle is made from silica.

17. A filter as set forth in claim 15, wherein the particle has a pore size ranging from about 2 nanometers (nm) to about 7 nm.

18. A filter as set forth in claim 15, wherein the particle is functionalized to target a particular contaminant in the fluid flow.

19. A filter as set forth in claim 15, wherein the adsorbent material further includes a carbon material capable of targeting a different contaminant than that targeted by SAMMS.

20. A filter as set forth in claim 1, wherein the contaminants being removed by the adsorbent material are different than those removed by the filter elements.

21. A method of manufacturing a filter treating contaminated fluid, the method comprising:
providing a first filter element and a second filter element for removing certain contaminants from a fluid flow, each filter element having an outer surface and an inner surface;
applying a layer of an adsorbent material on to the inner surface of one of the filter elements, the adsorbent material designed to remove additional contaminants from the fluid flow;
positioning the remaining filter element in opposing relations to the other filter element, so that its inner surface can be in substantial contact with the adsorbent material; and
bonding the filter elements to one another, so as to secure the adsorbent material therebetween.

22. A method as set forth in claim 21, wherein the step of providing includes making the filter elements from a permeable material.

23. A method as set forth in claim 22, wherein the step of making includes defining within the permeable material a substantially tortuous path from the outer surface to the inner surface of the filter element through which the fluid flow passes.

24. A method as set forth in claim 23, wherein, in the step of making, the permeable material is designed to trap contaminants of a predetermined size.

25. A method as set forth in claim 21, wherein, in the step of providing, the filter elements are made from a material including one of polyester, polypropylene, nylon, other polymeric materials, fiberglass or ceramic, microglass, melt-blown, micron synthetic, organic cellulose, paper, or a combination thereof.

26. A method as set forth in claim 21, wherein the step of providing includes designing the filter elements to be substantially flat in shape.

27. A method as set forth in claim 21, wherein the step of providing includes further providing the filter elements with a thickness of at least about 0.1 inch.

28. A method as set forth in claim 21, wherein, in the step of applying, the adsorbent material is designed to remove heavy metals from the fluid flow.

29. A method as set forth in claim 21, wherein, in the step of applying, the adsorbent material is designed to removed one of mercury, silver, lead, uranium, plutonium, neptunium, americium, arsenic, cadmium, or a combination thereof.

30. A method as set forth in claim 21, wherein, in the step of applying, the adsorbent material includes a porous particle made from self-assembled monolayers on mesoporous supports (SAMMS).

31. A method as set forth in claim 30, wherein the step of applying includes functionalizing the porous particle to target a particular contaminant in the fluid flow.

32. A method as set forth in claim 30, wherein, in the step of applying, the adsorbent material further includes a carbon material capable of targeting a different contaminant than that targeted by SAMMS.

33. A method as set forth in claim 21, wherein, in the step of applying, the contaminants being removed by the adsorbent material are different than those removed by the filter elements.

34. A method as set forth in claim 21, wherein the step of bonding includes heating the filter elements to permit melting of certain materials of the filter elements around the adsorbent material.

35. A method as set forth in claim 21, wherein the step of bonding includes applying pressure to one or both filter elements, so as to compress the filter elements toward one another.

36. A method as set forth in claim 21, further including joining a plurality of assembled filters to one another to provide a filter of a larger size.

37. A method as set forth in claim 36, wherein the step of joining includes employing ultrasonic welding techniques.

38. A method of treating contaminated fluid, the method comprising:
providing a filter having opposing filter elements designed to remove certain contaminants from a fluid flow, and an adsorbent material disposed between the filter elements for removing additional contaminants within the fluid flowing across one of the filter elements;
placing the filter over a contaminated area where seepage or low flow rate of contaminated fluid can be a problem, such that one filter element directly contacts the contaminated area;
permitting contaminated fluid from the area to flow across the one filter element in direct contact with the contaminated area, so as to remove contaminants of a certain size;
allowing the fluid to proceed across the adsorbent material, so as to remove additional contaminants different from those removed by the filter element in contact with the contaminated area; and
directing the fluid treated from the adsorbent material to move across the other filter element and away from the contaminated area.

39. A method as set forth in claim 38, wherein the step of providing includes making the filter elements from a permeable material.

40. A method as set forth in claim 38, wherein, in the step of providing, the filter elements are made from a material including one of polyester, polypropylene, nylon, other polymeric materials, fiberglass or ceramic, microglass, melt-blown, micron synthetic, organic cellulose, paper, or a combination thereof.

41. A method as set forth in claim 38, wherein the step of providing includes designing the filter elements to be substantially flat in shape.

42. A method as set forth in claim 38, wherein the step of providing includes further providing the filter elements with a thickness of at least about 0.1 inch.

43. A method as set forth in claim 38, wherein, in the step of providing, the adsorbent material is designed to remove heavy metals from the fluid flow.

44. A method as set forth in claim 38, wherein, in the step of providing, the adsorbent material is designed to removed one of mercury, silver, lead, uranium, plutonium, neptunium, americium, arsenic, cadmium, or a combination thereof.

45. A method as set forth in claim 38, wherein, in the step of providing, the adsorbent material includes a porous particle made from self-assembled monolayers on mesoporous supports (SAMMS).

46. A method as set forth in claim 45, wherein the step of providing includes functionalizing the porous particle to target a particular contaminant in the fluid flow.

47. A method as set forth in claim 45, wherein, in the step of providing, the adsorbent material further includes a carbon material capable of targeting a different contaminant than that targeted by SAMMS.

48. A method as set forth in claim 38, wherein the step of placing includes overlapping a plurality of assembled filters to provide a relatively larger filter to accommodate a relatively large contaminated area.

49. A method as set forth in claim 38, wherein the step of placing includes attaching a plurality of assembled filters to one another to provide a filter of a larger size.

50. A method as set forth in claim 49, wherein the step of attaching includes employing ultrasonic welding techniques.
